(19) United States
(12) Patent Application Publication
(10) Pub. No.: US 2007/0268634 A1
(43) Pub. Date: Nov. 22, 2007

(54) Power supply system

(75) Inventors: Knut Ivar Gjerde, Drammen (NO); Erik Myhre, Asker (NO)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Eltek Energy AS

(21) Appl. No.: 11/797,719

(22) Filed: May 7, 2007

(30) Foreign Application Priority Data
May 8, 2006 (NO) 20062046

(51) Int. Cl. H02H 9/00

(52) U.S. Cl. 361/18

(57) ABSTRACT

Switch mode power supply system, characterized in that it comprises at least one power supply module (10) supplying at least two controlled DC output voltages through respective first connection means (22, 24), where the two first connection means (22, 24) are electrically insulated from each other; a connection device (30) comprising a first connection interface (32) with first output terminals (38, 39) for connection to a first load and a second connection interface (62) with second output terminals (68, 69) for connection to a second load, where each connection interface (32, 62) comprises second connection means (34) for connection to the first connection means (22, 24) of the at least one module (10); where the power supply system is supplying power at a first voltage level when connected to the first connection interface (32) and supplying power at a second voltage level when connected to the second connection interface (62).

### FIELD OF THE INVENTION

The present invention relates to a power supply system. More specifically, the invention relates to a switch mode power supply system having a high output power where the output voltage can be changed between two different levels.

### BACKGROUND OF THE INVENTION

Power supply systems used in high power applications are commonly used. The present invention especially relates to power supply systems for telecommunication equipment, but of course, the present invention also can be used for equipment in other applications.

Such power supply systems comprise rectifiers, AC/DC converters, DC/DC converters etc. Often, the power supply systems also provide electric insulation between the AC mains and the output voltage.

Power supply systems are usually sold and delivered as modules for mounting into a rack. Preferably, the modules are “hot-plug” modules, i.e. modules can be connected to and disconnected from the rack without turning the power supply system completely off.

In the telecommunication industry, base stations for the GSM mobile telephone system (GSM: Global System for Mobile Communications) can for example be supplied with +24 V DC. Many mobile telephone operators have now started to or are planning to update their base stations to the UMTS system (UMTS: Universal Mobile Telecommunications System), which for example can be based on −48 V DC. New base stations will comprise both GSM and UMTS equipment, but the future power needed for each system will probably be unknown for the operators.

Consequently, many base stations today need power supply systems for one first type of equipment, but will gradually replace or add to the first type of equipment with a second type of equipment. Therefore, many base stations are today comprising both −48V DC and +24V DC power supply systems and both systems will exist in parallel for many years.

It should be noted that the voltage levels and polarities mentioned here are given as an example only, these requirements will vary based on product, manufacturer etc.

Accordingly, there is a need for power supply systems that can be used for both voltage levels. One such known approach is the RM 750 power supply from Voigt & Haeffner (http://www.vuh.de/en/files/datasbeets/Rectifiers.pdf), which is a rectifier having an electric switch that changes the output voltage between 24, 48 and 60 V. The switch action results in an analogue or electronic change in the control circuit of the power supply, which again causes a change in output voltage.

The large disadvantage with this solution is that when a low voltage level is used, the output power will be substantially lower than when a higher voltage level is used. It should be mentioned that when this type of power supply is used, a physical disconnection from the load supplied with the first voltage level is performed, and thereafter, a new connection to the load supplied with the second or third voltage level is performed.

The object of the present invention is to provide a power supply system that can be configured to be used at two different voltage levels, while the same output power is supplied at both levels. Moreover, it is an object to simplify and to reduce costs related to the planning process of complex power supply systems. Another object is that it should be relatively easy to reconfigure the power supply system from the first to the second output voltage level and vice versa.

### SUMMARY OF THE INVENTION

The present invention relates to a switch mode power supply system. The system is characterized in that it comprises:
at least one power supply module supplying at least two controlled DC output voltages through respective first connection means, where the two first connection means are electrically insulated from each other;
a connection device comprising a first connection interface with first output terminals for connection to a first load and a second connection interface with second output terminals for connection to a second load, where each connection interface comprises second connection means for connection to the first connection means of the at least one module;
   where the power supply system is supplying power at a first voltage level when connected to the first connection interface and supplying power at a second voltage level when connected to the second connection interface.

According to the invention, the abovementioned objects are achieved.

In a preferred embodiment of the invention the first output terminals of the first connection interface represents a parallel connection of the at least two output voltages of the at least module and the second output terminals of the second connection interface represents a serial connection of the at least two output voltages of the at least one module. In this way, it is possible for all modules to supply full power.

In a preferred embodiment of the invention the least one power supply module comprises one separate rectifier device for each DC output voltage. Each rectifier device have separate input and separate output, and they are preferably electrically insulated from each other. In an alternative embodiment, the least one power supply module comprises one common rectifier device. Here, the rectifier devices of the power module have common input and common rectifying, while the stage performing the controlled DC output is separated.

Respective rectifier is preferably supplied with an AC power from an AC power source through the first connection means.

The power supply module can also comprise a DC/DC converter which is supplied with a DC power from an DC power source through the first connection means.

In a preferred embodiment, the connection device provides connection to several power supply modules (10; 10a, 10b), either to one of, or both first and second connection interfaces. For example the connection device can have four second connection means at each connection interface, where two power modules can be connected to the first or second connection interface, or one power module can be connected to the first connection device while the other power module is connected to the second connection device. It is of course possible to have only one power module, then only one output voltage level at a time is possible. In preferred embodiments, two or more power modules is connected to the same connection device.

In a preferred embodiment, the first connection means of the power supply module comprises a connection slot and the second connection means of the connection device is outwardly protruding and adapted to be received into the connection slot.

In a preferred embodiment, the power supply system comprises a monitoring and control device connected to each power supply module through a data bus via the first connection means.

It should be noted that in practical applications, the connection device is fixed to a rear side of a rack, while the power supply modules are inserted through the front side of the rack. The total power supply system will in such cases often comprise many connection devices and many power supply modules mounted in racks.

### DETAILED DESCRIPTION OF THE PREFERRED EMBODIMENT

In the following, the preferred embodiment of the invention will be described in detail as an example, where it is referred to the following drawings:

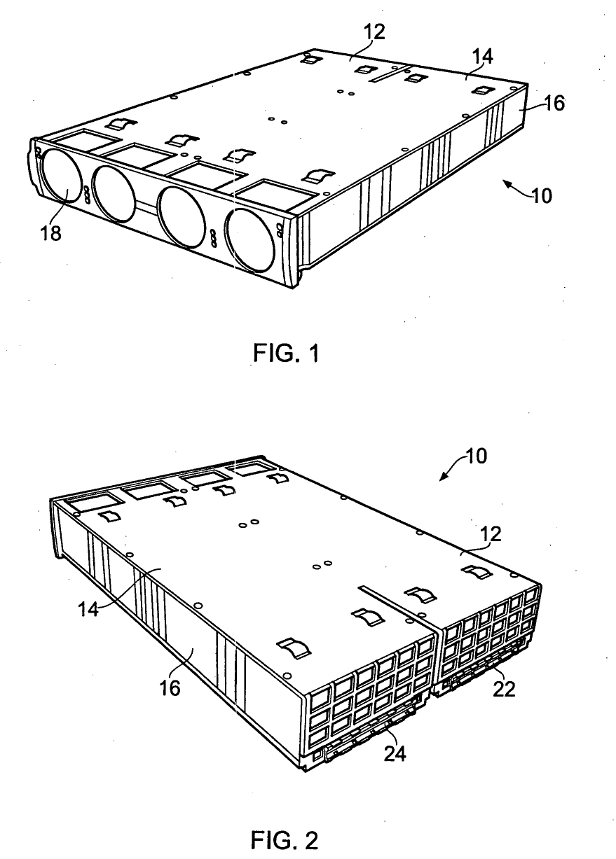

FIG. 1 shows a front perspective view of a power supply module used in the present invention;

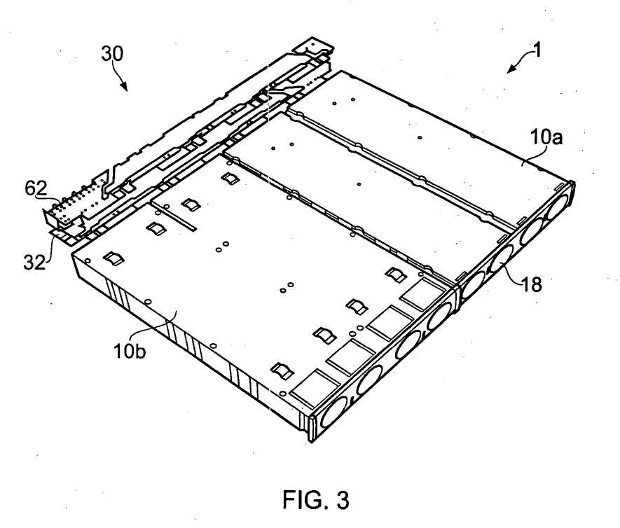

FIG. 2 shows a rear perspective view of the power supply module in FIG. 1;

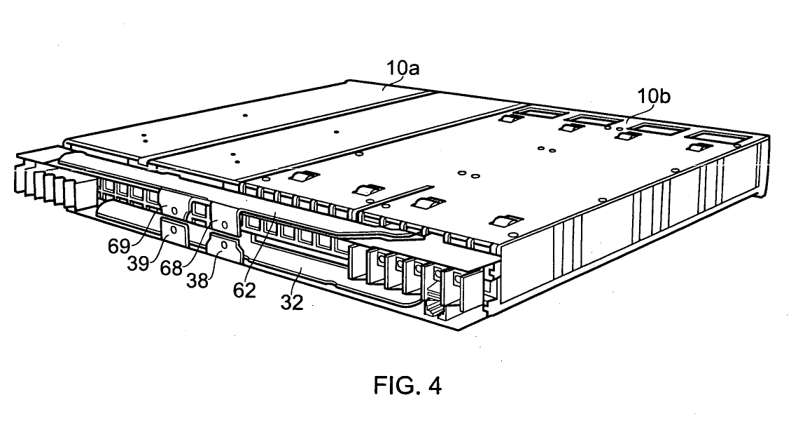

FIG. 3 shows a front perspective view of the power supply system according to the invention, comprising two power supply modules and a connection device;

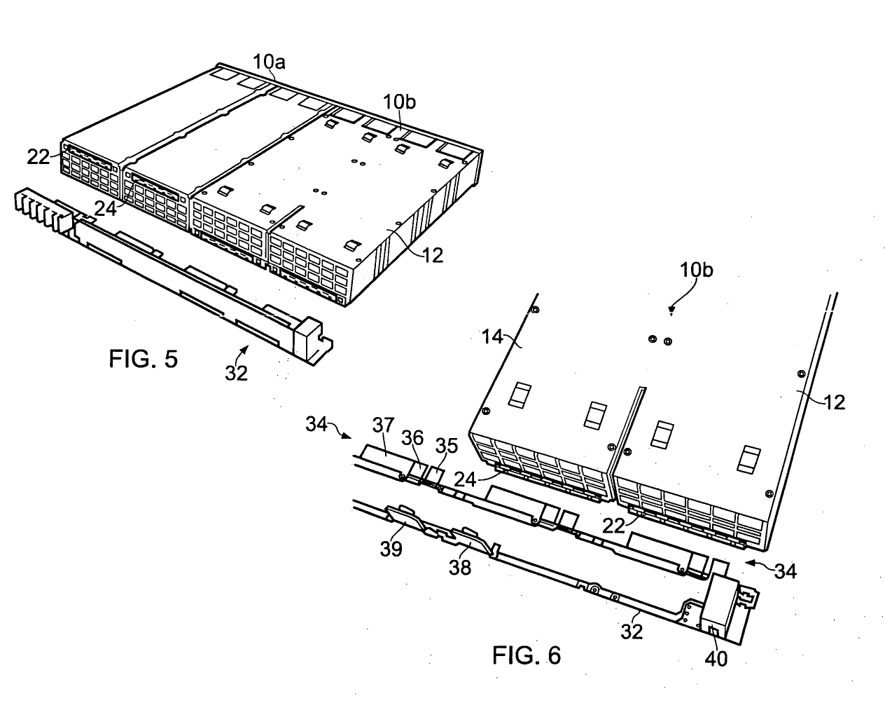

FIG. 4 shows a rear perspective view of the power supply system in FIG. 3;

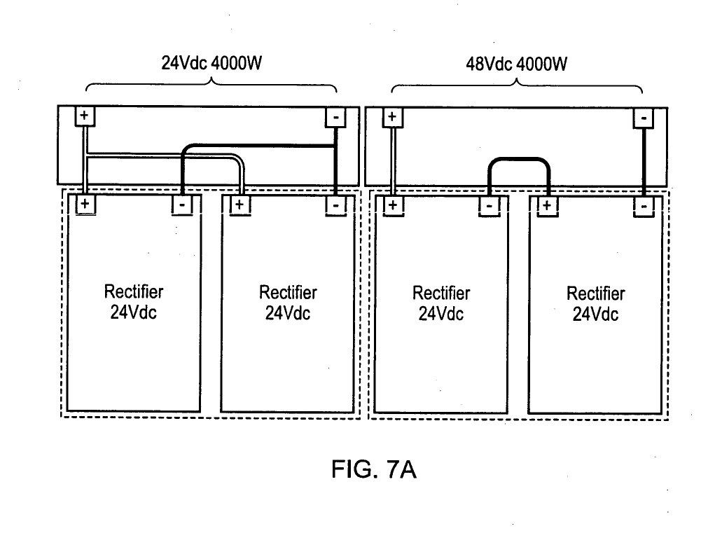

FIG. 5 shows the lower part of the connection device and one of the power supply modules;

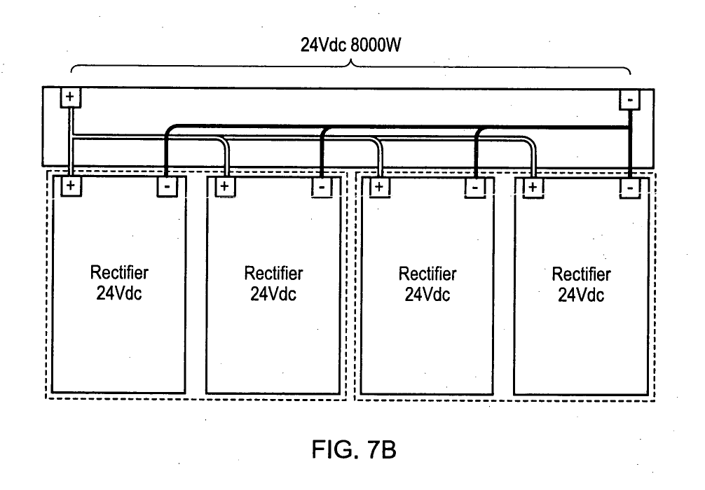

FIG. 6 shows a detail of FIG. 5;

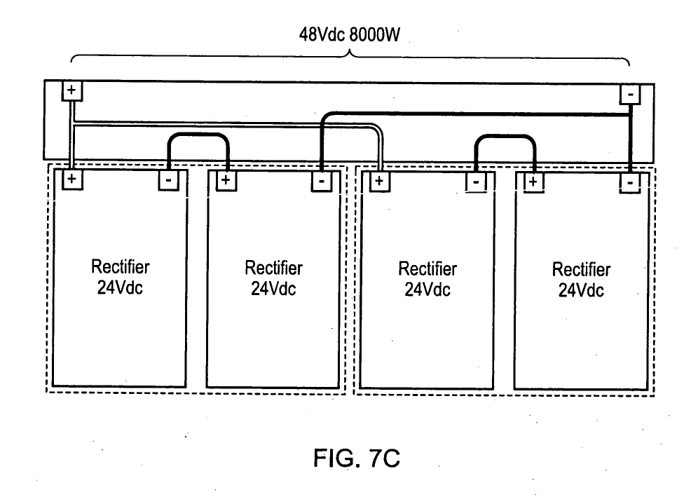

FIG. 7a illustrates the connection for a combined −48/+24 V DC where 4000 W is supplied for each voltage level;

FIG. 7b illustrates the connection for a +24 V DC where 8000 W is supplied; and

FIG. 7c illustrates the connection for a −48 V DC where 8000 W is supplied,

It will now be referred to FIGS. 1 and 2, which shows a power supply module 10. In the preferred embodiment of the invention, the power supply module 10 comprises two rectifiers 12, 14 located in a common housing 16. In the front of the housing 16 there is provided a number of cooling fans 18.

The power supply module 10 is adapted to be mounted in a rack (not shown). On the rear side (see FIG. 2) the module 10 comprises two connection slots 22, 24 for input/output to respective rectifier 12, 14. The connection slots 22, 24 will be described in detail below, with reference to FIG. 6.

The rectifier 12, 14 comprises a converter performing an AC/DC conversion. In the preferred embodiment, each rectifier 12, 14 is comprising a slightly modified FlatPack2 rectifier, as described on http://www.flatpack2.com. The two rectifiers 12, 14 are not electrically connected to each other—they have separate connection slots each providing 24 V DC output (Please note that the FlatPack2 is delivered different versions: 24 VDC, 48 VDC or 60 VDC).

However, it shall be noted that the rectifier in the preferred embodiment is slightly modified:
the ground level of the digital communication bus is electrical insulated from the rectifiers ground level.
the control and monitoring software is modified so that the requirements for the module as one product is meet (EMC and safety requirements)

FIG. 3 shows the power supply system 1 according to the invention. The power supply system 1 comprises two power supply modules 10 (hereinafter referred to as modules 10a, 10b respectively) and a connection device 30. In the present embodiment the width of the rack is 19″ (a common/standard width for telecommunication applications) and the two modules have a total width adapted for insertion into such a rack. The connection device 30 is fixed to the rear side of the rack and is adapted to receive and electrically connect to the two modules 10a, 10b.

The connection device 30 will now be described with reference to FIG. 3-6. In the preferred embodiment, the connection device 30 comprises a lower connection interface 32 and an upper connection interface 62.

The lower connection interface 32 is shown in detail in FIGS. 5 and 6 and will now be described. It shall be noted that the upper connection interface 62 comprises the same components 62, as will be apparent from the description below.

The lower connection interface 32 comprises four connectors 34, each of which is adapted for connection to the connection slots 22, 24 of respective rectifier 12, 14. The connector 34 comprises one positive input terminal 35, one negative input terminal 36 and one circuit card device 37, all of which is adapted for insertion into connection slots 22, 24. The circuit card device 37 comprises several electrical connectors, such as the connectors for AC supply to the power supply module and communication signals for transfer via a CAN-bus.

The lower connection interface 32 is also having several contact terminals on the opposite side, such as a negative output terminal 38 and a positive output terminal 39 connected to the telecommunication equipment, a CAN-bus terminal 40 and an AC input (not shown) connected to an AC power supply system. The CAN-bus terminal 40 is preferably connected to a monitoring device (in the preferred embodiment this is the SmartPack controller, information can be found on www.flatpack2.com).

As will be apparent for a person skilled in the art, the negative input terminal 35 is connected to the negative output terminal 38 and the positive input terminal 36 is connected to the positive output terminal 39. Further, the communication signals from the circuit card device 37 is connected to the CAN-bus terminal 40 and the AC supply of the circuit card device 37 is connected to the AC input.

As mentioned above, the lower connection interface 32 is fixed on the rear side of the rack (not shown). In FIG. 5 it is shown that the connection slots 22, 24 of a power supply module 10b is electrically connected to two connectors 34 of the lower connection interface 34 when the module is pushed towards the connection interface. Please note that the module 10b is turned in a position where the connection slots 22, 24 are on the lower rear side of the module 10b.

In FIG. 5 it is also shown a power supply module 10a turned 180 degrees to a position where the connection slots 22, 24 are on the upper rear side of the module 10a. When the module 10a is inserted into the rack, an electrical connection with the upper connection interface 62 will be achieved (FIG. 4 shows module 10a connected to upper connection interface 62 and module 10b connected to lower connection interface 32). DC output terminals 38, 39 of the lower connection interface 32 (24 V) and DC output terminals 68, 69 of the upper connection interface 62 (48 V) are also shown here.

It should be noted that the mechanical support of the modules 10a and 10b is provided by the rack (not shown).

The different configurations that can be achieved by utilizing the invention is shown in FIG. 7a -b. Only the DC output connections are shown.

FIG. 7a illustrates the invention connected similar to FIG. 4. Here the power supply module 10b is connected to the lower connection interface 32 and supplies an output of 4000 W (24 V DC) while the power supply module 10a is connected to the upper connection interface 62 and supplies an output of 4000 W (−48 V DC). As illustrated, the two rectifiers of module 10b are connected in parallel, while the two rectifiers of module 10a are connected in series.

In FIG. 7b the power supply module 10b is turned 180 degrees around compared with FIG. 7a. Here both the power supply module 10b and the power supply module 10a is connected to the lower connection interface 32 and supplies an output of 8000 W (24 V DC). As illustrated, all four rectifiers of module 10b and 10b are connected in parallel.

In FIG. 7c the power supply module 10a is turned 180 degrees around compared with FIG. 7a. Here both the power supply module 10b and the power supply module 10a is connected to the upper connection interface 62 and supplies an output of 8000 W (−48 V DC). As illustrated, the two rectifiers of module 10b are connected in parallel and the two rectifiers of module 10a are connected in parallel, while module 10a and 10b are connected in series.

It should be noted that when one of the modules in FIG. 7b or 7c is disconnected, the remaining module will still continue to supply power to the load. The disconnection will of course affect input/output current and voltage from the power supply system, but as long as the load is not outside the operating limits of the power supply system, there is no need to perform a shutdown of the load.

In the preferred embodiment, the power supply system 1 further comprises a monitoring and control device for monitoring the state (for example temperature, output voltage, current, rectifier status and info, battery analyzing and distribution monitoring etc) of each power supply module and to control the switches of the modules accordingly. According to this embodiment, several power supply modules are connected together via the CAN bus to a central monitoring module which perform overall system monitoring and control, to provide system analysis, system warnings etc.

In the preferred embodiment the monitoring and control device will detect a disconnection of one module in FIGS. 7b and 7c, and adjust the output of the power supply system to the load accordingly.

According to the invention described above, a power supply system is achieved that can be configured to be used at two different voltage levels, while the same output power is supplied at both levels. The planning process of complex power supply systems is simplified and flexible, since there is no need to specify the total power needed at each voltage level. Moreover, it is relatively easy to reconfigure the power supply system from the first to the second output voltage level and vice versa.

Modifications

It will of course be appreciated that the principle described above also can be used with other output voltage levels than +24 and −48. Moreover, the same principle can be extended to a power supply system with three, four or even more power supply modules being combined to provide two or even more different voltage levels. As an example, the power supply system according to the invention can comprise four power supply modules each with an output voltage of +24V DC. Three different configurations is possible, a first output level of +24V DC (all modules connected in parallel), +48V DC (two parallel pairs of modules, each pair connected in series and +96 V DC. (all modules connected in series). Consequently, there should be three ways to connect the connection device to the power supply modules.

Of course it is also possible to use only one power supply module together with a connection device 30 only comprising two connectors 34 at each connection interface. In this embodiment, it is only possible to supply one output voltage level at a time.

In the description above, the pair of modules is pulled out from the rack and then turned 180 degrees around before inserting them again. It is of course possible to provide a mechanical arrangement where the connection device 30 is disconnected, repositioned and reconnected again.

The present invention is described with reference to switch mode power supply systems. It is also possible to use the invention with series regulators or other equipment.

Further modifications and variations will be obvious for a skilled man when reading the description above. The scope of the invention will appear from the following claims and their equivalents. A man skilled in the art will of course amend the polarities and voltage levels due to the load requirements.

1. Switch mode power supply system comprising at least one power supply module (10) and a connection device (30), characterized in that:
the at least one power supply module (10) is supplying at least two controlled DC output voltages through respective first connection means (22, 24), where the two first connection means (22, 24) are electrically insulated from each other;
the connection device (30) is comprising a first connection interface (32) with first output terminals (38, 39) for connection to a first load and a second connection interface (62) with second output terminals (68, 69) for connection to a second load, where each connection interface (32, 62) comprises second connection means (34) for connection to the first connection means (22, 24) of the at least one module (10);
the power supply system is supplying power at a first voltage level when the at least one module (10) is connected to the first connection interface (32) and is supplying power at a second voltage level when the at least one module (10) is connected to the second connection interface (62).

2. System according to claim 1, characterized in that the first output terminals (38, 39) of the first connection interface (32) represents a parallel connection of the at least two output voltages of the at least one module (10) and the second output terminals (68, 69) of the second connection interface (62) represents a serial connection of the at least two output voltages of the at least one module (10).

3. System according to claim 1 or 2, characterized in that the least one power supply module comprises one separate rectifier device (12, 14) for each DC output voltage.

4. System according to claim 1 or 2, characterized in that the least one power supply module comprises one common rectifier device.

5. System according to claim 3 or 4, characterized in that respective rectifier is supplied with an AC power from an AC power source through the first connection means (22, 24).

6. System according to claim 1 or 2, characterized in that the least one power supply module comprises at least one DC/DC converter supplied with a DC power from an DC power source through the first connection means (22, 24).

7. System according to one of the claims above, characterized in that the connection device (30) provides connection to several power supply modules (10; 10a, 10b), either to one of, or both first and second connection interfaces (32, 62).

8. System according to one of the claims above, characterized in that first connection means (22, 24) of the power supply module (10) comprises a connection slot and the second connection means (34) of the connection device (30) is outwardly protruding and adapted to be received into the connection slot.

9. Device according to one of the above claims, characterized in that the power supply system comprises a monitoring and control device connected to each power supply module (10) through a data bus via the first connection means (22, 24).
